(19) United States
(12) Patent Application Publication
(10) Pub. No.: US 2011/0119756 A1
(43) Pub. Date: May 19, 2011

(54) Method Of Managing Usage Of A Workstation And Desktop Management System Therefor

(75) Inventors: Scott McClusky, Phoenix, AZ (US); Guoqiang Li, Maricopa, AZ (US)

(73) Assignee: Carefx Corporation, Scottsdale, AZ (US)

(21) Appl. No.: 12/698,795

(22) Filed: Feb. 2, 2010

Related U.S. Application Data
(60) Provisional application No. 61/262,306, filed on Nov. 18, 2009.
(60) Provisional application No. 61/288,020, filed on Dec. 18, 2009.

(51) Int. Cl. G06F 9/00; G06F 21/00; G06F 15/16

(52) U.S. Cl. 726/17; 713/2; 709/227

(57) ABSTRACT

Embodiments can disclose a method of managing usage of a workstation. The method can include: performing a desktop management sequence; performing a start-up sequence; displaying a login graphic on a screen of a monitor of the workstation; receiving first login information from a user; validating the first login information to check if the user is authorized to use the workstation; if the user is authorized to use the workstation, performing an autolaunch sequence, where performing the autolaunch sequence can include starting one or more pervasive computer applications; checking to see if the one or more pervasive computer application is active; if at least one first application of the one or more pervasive computer applications is not active, restarting the at least one first application of the one or more pervasive computer applications; receiving one or more instructions to logout from the user; and closing the one or more pervasive computer applications. Other embodiments are disclosed herein.

### CROSS-REFERENCE TO RELATED APPLICATIONS

This application claims the benefit of U.S. Provisional Application No. 61/262,306, filed Nov. 18, 2009 and U.S. Provisional Application Ser. No. 61/288,020, filed Dec. 18, 2009. U.S. Provisional Application Ser. Nos. 61/262,306 and 6161/288,020 are incorporated herein by reference.

### FIELD OF THE INVENTION

This invention relates to desktop management systems in general, and relates more particularly to a computer system for managing and controlling access to one or more workstations and methods for the same.

### DESCRIPTION OF THE BACKGROUND

In many fields, two or more users might use a single workstation at different times. For example, in the healthcare field, various nurses, doctors, and other healthcare professions might use a workstation located at a nurse's station at a hospital. Managing the shared workstation presents issues and challenges. Typically, most organizations leave the management of the workstation to the operating system running on the workstation. While the operating system on the workstation provides some methods to control access to applications and data, these operating system are not sophisticated enough to provide efficient desktop management needed in the healthcare field and other fields. Accordingly, a need or potential for benefit exists for a desktop management system that provides an efficient and comprehensive desktop for a workstation.

### BRIEF DESCRIPTION OF THE DRAWINGS

To facilitate further description of the embodiments, the following drawings are provided in which:

FIG. 1 illustrates a block diagram of a desktop management system configured to manage one or more workstations, according to a first embodiment;

FIG. 2 illustrates a flow chart for an embodiment of a method of managing usage of a workstation, according to the first embodiment;

FIG. 3 illustrates an example of an activity of switching to a new profile, according to the first embodiment;

FIG. 4 illustrates a flow chart for an example of an activity of receiving login information from a user and validating an identity of the user, according to the first embodiment;

FIG. 5 illustrates a flow chart for an example of an activity of performing a network reconnection, according to the first embodiment; and

FIG. 6 illustrates a computer that is suitable for implementing an example of computer system of FIG. 1; and

FIG. 7 illustrates a representative block diagram of an example of the elements included in the circuit boards inside chassis of the computer of FIG. 6.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the coupling, etc. in question is or is not removable

### DETAILED DESCRIPTION OF EXAMPLES OF EMBODIMENTS

Embodiments can disclose a method of managing usage of a workstation. The method can include: performing a desktop management sequence; performing a start-up sequence; displaying a login graphic on a screen of a monitor of the workstation; receiving first login information from a user; validating the first login information to check if the user is authorized to use the workstation; if the user is authorized to use the workstation, performing an autolaunch sequence, where performing the autolaunch sequence can include starting one or more pervasive computer applications; checking to see if the one or more pervasive computer application is active; if at least one first application of the one or more pervasive computer applications is not active, restarting the at least one first application of the one or more pervasive computer applications; receiving one or more instructions to logout from the user; and closing the one or more pervasive computer applications.

Further embodiments disclose another method of desktop management of a workstation. The method can include: switching to a first profile to prepare a desktop of the workstation for use by a user; switching to a second profile where switching to the second profile can include starting one or more first computer applications where a first application of the one or more first computer applications requires a connection to a network to operate properly; monitoring to determine if a second application of the one or more first computer applications is still running at one or more first predetermined intervals; if the second application of the one or more first computer applications is not running, restarting the second application of the one or more first computer applications; monitoring to determine if the connection to the network is still active at one or more second predetermined intervals; if the connection to the network is not active, switching to a network disconnect profile; and if the connection to the network becomes active, switching to a network reconnect profile.

Some embodiments disclose a system configured to manage a workstation. The system can include: (a) a login module configured to login a user and validate login information of the user; (b) a pervasive monitoring module configured to monitor that one or more pervasive computer applications are running while the user is logged-in to the workstation; (c) a start-up module configured to restart the one or more pervasive computer applications if the one or more pervasive computer applications are not running; (d) a profile management module configured to manage one or more profiles; (e) a logout module configured to logout the user; and (f) a network monitor module configured to monitor a network connection to a network and manage usage of the network by one or more first computer applications.

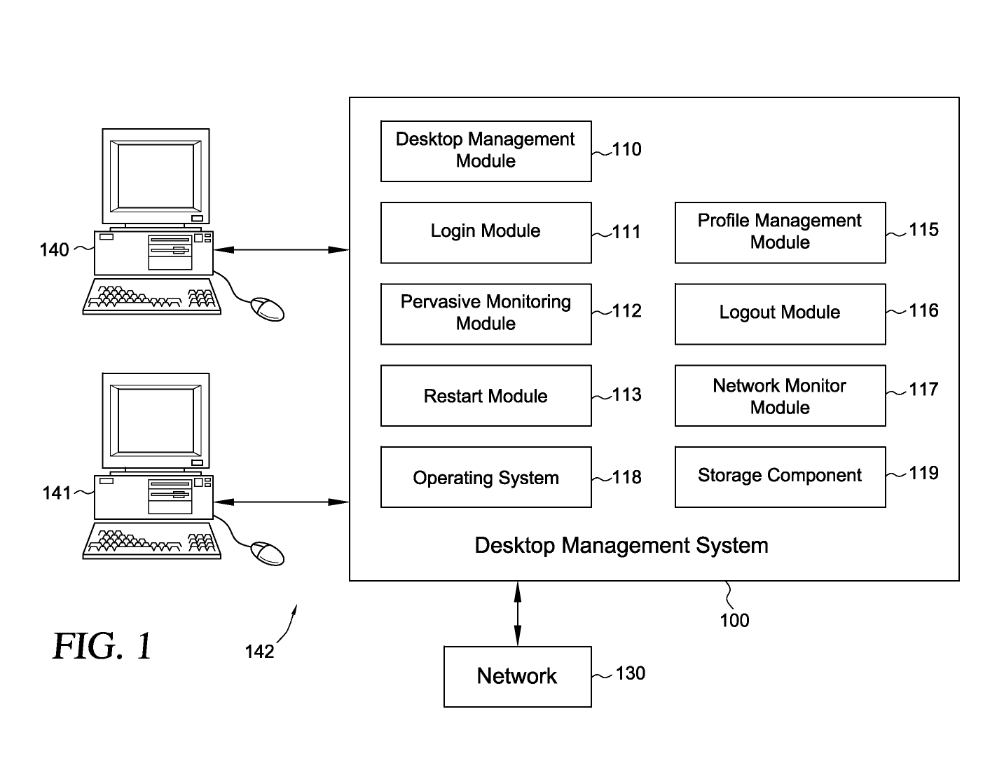

Turning to the drawings, FIG. 1 illustrates a block diagram of a desktop management system 100 configured to manage one or more workstations 140 and 141, according to a first embodiment. Desktop management system 100 is merely exemplary and is not limited to the embodiments presented herein. Desktop management system 100 can be employed in many different embodiments or examples not specifically depicted or described herein.

In some embodiments, desktop management system 100 is configured to manage one or more workstations 140 and 141. Desktop management system 100 can include: (a) a desktop management module 110; (b) a login module 111 configured to facilitate the login of one or more users and validation of the login information of the users; (c) a pervasive monitoring module 112 configured to monitor that one or more pervasive computer applications are running; (d) a restart module 113 configured to restart the one or more pervasive computer applications if the one or more pervasive computer applications are not running; (e) a profile management module 115 configured to manage one or more profiles; (f) a logout module 116 configured to facilitate the logout of users; (g) a network monitor module 117 configured to monitor a network connection to a network 130 and manage usage of network 130 by one or more applications; (h) an operating system 118; and (i) a storage component 119. In various embodiments, desktop management system 100 can be run on a computer system 142. In some examples, computer system 142 can be coupled to network 130 (e.g., the Internet)

“Computer system 142,” as used herein, can refer to a single computer, single server, or a cluster or collection of servers. In these examples, computer system 142 could be a server or a cluster or collection of servers, other than workstations 140 and/or 141. More than one server can be used when the demands by workstations 140 and 141 are beyond the reasonable capability of a single server or computer. In many embodiments, the servers in the cluster or collection of servers are interchangeable from the perspective of workstation 140 and 141.

In various embodiments, at least one of desktop management module 110, login module 111, pervasive monitoring module 112, restart module 113, profile management module 115, logout module 116, or network monitor module 117 module are running on a first server. In the same or different embodiment, at least one of desktop management module 110, login module 111, pervasive monitoring module 112, restart module 113, profile management module 115, logout module 116, or network monitor module 117 are running on one or more second servers. In these examples, computer system 142 can comprise the combination of the first server and the one or more second servers.

In another embodiment, one or more of the desktop management module 110, login module 111, pervasive monitoring module 112, restart module 113, profile management module 115, logout module 116, and/or network monitor module 117 module are running on workstation 140 and/or workstation 141 (i.e., workstation 140 and/or workstation 141 can be computer system 142). That is, in some examples, a user can run desktop management system 100 on the workstation to which the user is physically using.

In some examples, storage component 119 can include information about the configuration and operation of desktop management system 100. For examples, storage component 119 can store one or more profiles, global settings for desktop management system 100, and configurations and settings for one or more computer applications.

Desktop management system 100 can use profiles to manage the usage of workstations 140 and/or 141. For example, when a profile is active, workstation 140 is controlled by the profile's settings and configuration, along with any global settings for desktop management system 100 and the settings and configuration of one or more applications.

A profile can include at least: (a) a name of the profile; (b) a list of application to be started by the profile; (c) a list of application to be kept running while the profile is active (i.e., a list of pervasive applications); and (d) configurations and settings that manage aspects of the user's use of the workstation (e.g., the settings of whether a task bar, the desktop, and/or start button are accessible to the user while this profile is active, and the interval of time between check to see if the pervasive application are active). In some examples, the settings and configurations of a profile can include a setting to whether the profile is enabled. If the profile is not enabled, profile management module 115 will not switch to the profile. In some examples, if desktop management system 100 tries to switch to a disabled profile, profile management module 115 will switch to a default profile instead of the disabled profile. A system administrator might want to disable one or more profiles if the profile is still in the process of being built and tested and/or if the profile causes problems when activated.

In additional to the items discussed above, a profile can include a list of applications to be started and the order in which the application are to be started. A profile can also include information regarding a time delay, if any, that should be applied between starting certain applications. That is, an application might require one or more other applications to be running for the application to function properly. Accordingly, in some examples, it is necessary to wait a predetermined time after starting a first application before starting a second application. If the second application requires the first application to be running before the second application can start properly, a profile can include information regarding how long profile management module 115 (FIG. 1) should wait before starting the second application after the first application has been started.

In some examples, desktop management system 100 can include at least the following profiles: (a) an autolaunch profile configured to start any applications a user might want to use while logged-in to desktop management system 100; (b) a network disconnect profile to run when the network connectivity to network 130 is lost; (c) a network reconnect profile to run when the network connectivity to network 130 is restored; (d) an operational profile configured to be the active profile during normal usage of workstation 140 or 141 by the user; (e) a start profile configured to automatically run when desktop management system 100 starts to prepare desktop management system 100; and (f) a logout profile configured to run when a user wants to logout of desktop management system 100. In the same or different examples, desktop management system 100 can include additional profiles. For example, desktop management system can include one or more profiles specifically tailored to the needs of an individual user or a group of users (e.g., a specific profile for emergency room nurses). Desktop management system 100 can also include one or more profiles designed to perform specific tasks or designed to run when a specific trigger occurs.

In addition to the information regarding profiles, storage component 119 can include configurations and settings information about one or more applications. In some embodiments, the applications are separate from desktop management system 100. The applications can be one or more computer applications that a user might want to run to perform a specific task.

This application configuration information, stored in storage component 119, can include at least the following configuration information: (a) application specific parameters used when starting and running the application; (b) location information regarding where the information and files related to the application are stored; (c) whether desktop management system 100 should restart the application if the application is not running (i.e., is the application a pervasive application); (d) whether the application is network dependent (i.e., does desktop management system 100 need to be connected to network 130 for the application to function properly); (e) information regarding any dependencies of the application for proper starting (i.e., does this application require one or more other applications to be running for this application to start and function properly); (f) shutdown options for the application (i.e., whether the application can be stopped and all resources used by the application freed when the main window of the application is closed or when the user logs out); (g) whether desktop management system 100 should display the main window for the application when starting the application; (h) whether desktop management system 100 uses the operating system shell when starting the application; (i) information regarding any dependencies of the application for proper shutdown of the application (i.e., does one or more other applications need to be shutdown a predetermined time before or after this application for this application to shutdown properly); (j) is this application enabled or disabled (if an application is disabled, users cannot use the application) and (k) the size of the main window when the application is active. In some example, system administrators can configure these application settings, or default settings can be used.

Storage component 119 can also store information regarding global settings for desktop management system 100. For example, storage component 119 can store the following global settings: (a) configuration settings for the start-up of desktop management system 100 (e.g., path and file name for desktop management system 100) ; (b) configuration settings for the shut down of desktop management system 100; (c) information regarding the idle timeout period and screen saver information; (d) start and stop information for locking down workstation 140 and/or 141; (e) information regarding monitoring network connectivity (e.g., name or Internet Protocol (IP) address for one or more computers to ping to check network connectivity, the interval between network connectivity checks, and number of consecutive times that the network connectivity check must fail for desktop management system to determine no network connection exists); (f) information regarding monitoring pervasive applications; (g) information regarding user access to system information (e.g., information on whether the name of the active profile is shown to the user); and (h) login and password information for configuring desktop management system 100. In some example, system administrators can configure these global settings, or default global settings can be used.

The profile information, application configuration information, and the global settings can be a structured collection of records or data, for instance, which is stored in storage component 119. For example, the indexes stored in storage component 119 can be an XML (Extensible Markup Language) database, MySQL, or an Oracle® database. In the same or different embodiments, the indexes could consist of a searchable group of individual data files stored in storage component 119.

In various embodiments, operating system 118 can be a software application that manages the hardware and software resources of a computer and/or a computer network. Operating system 118 performs basic tasks such as, for example, controlling and allocating memory, prioritizing the processing of instructions, controlling input and output devices, facilitating networking, and managing files. Examples of common operating systems (OS) include Microsoft® Windows® OS, Mac® OS, UNIX® OS, and Linux® OS.

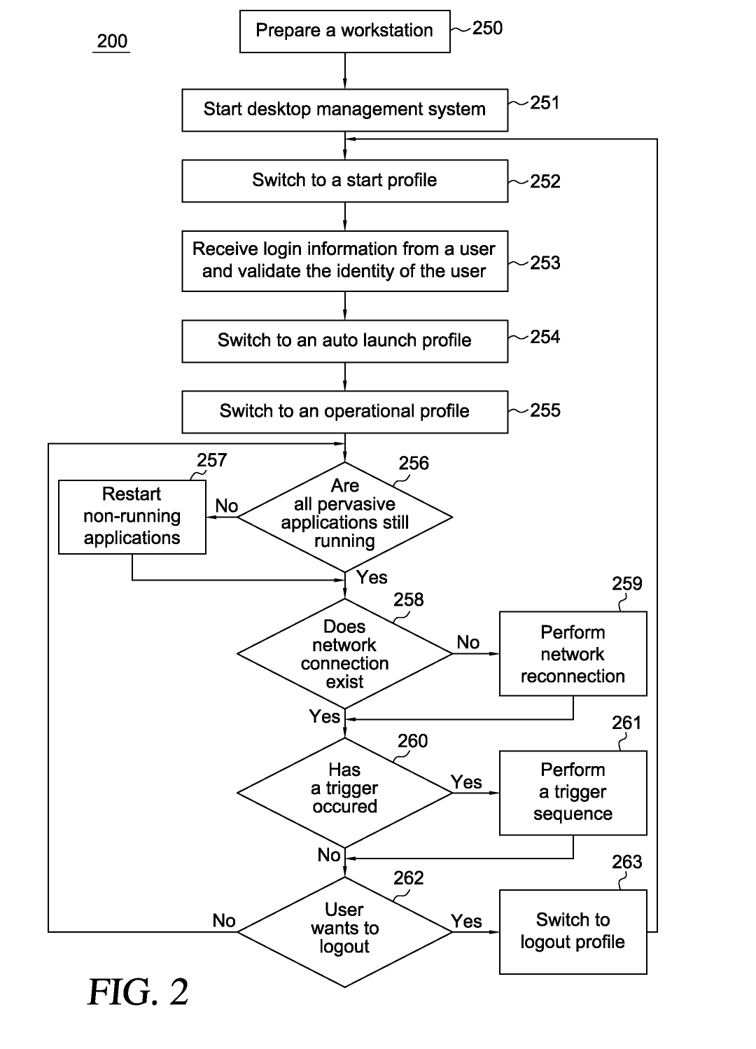

FIG. 2 illustrates a flow chart for an embodiment of a method 200 of managing usage of a workstation, according to the first embodiment. Method 200 is merely exemplary and is not limited to the embodiments presented herein. Method 200 and desktop management system 100 (FIG. 1) can be employed in many different embodiments or examples not specifically depicted or described herein.

Referring to FIG. 2, method 200 can include an activity 250 of preparing the workstation. In some examples, preparing the workstation can include turning-on the workstation, shutting down applications other than desktop management system 100 (FIG. 1), or otherwise preparing the workstation for use with desktop management system 100 (FIG. 1). In some examples, the workstation can be similar or identical to workstations 140 and/or 141 (FIG. 1).

Method 200 continues with an activity 251 of starting a desktop management system. In some examples, starting the desktop management system can be part of a desktop management sequence. As an example, the desktop management system can be similar or identical to desktop management system 100 of FIG. 1. In some examples, the start-up procedure for a workstation can automatically start the desktop management system. For example, if the workstation is running Microsoft® Windows® OS as the operating system, the desktop management system can be automatically loaded and run by Microsoft® Windows® OS during the boot-up process. In various embodiments, Microsoft® Windows® OS can be instructed to run the desktop management system during the boot-up process by adding the desktop management system start-up executable to certain Windows® system registry keys.

Next, method 200 can include an activity 252 of switching to a start profile. In some examples, switching to the start profile can be part of a start-up sequence. In some examples, the start profile can prepare the workstation for use by a user without activating any triggers (triggers are described below) when idle for long periods of time.

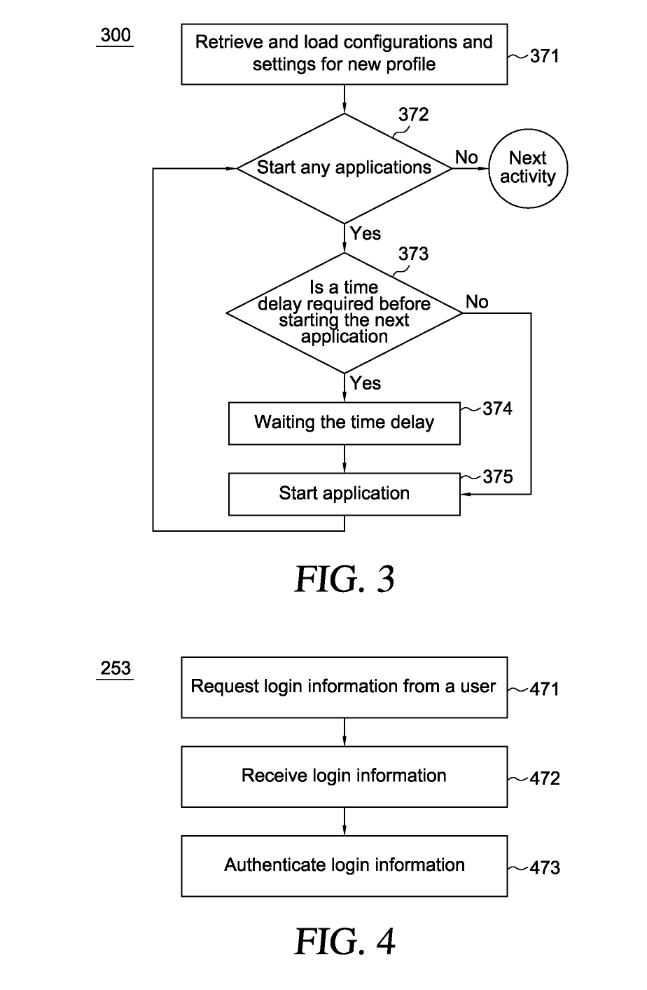

FIG. 3 illustrates an embodiment of an activity 300 of switching to a new profile, according to the first embodiment. Activity 300 is merely exemplary and is not limited to the embodiments presented herein. Activity 300 can be employed in many different embodiments or examples not specifically depicted or described herein. In this example, the new profile being switched to is the start profile.

Referring to FIG. 3, the first procedure in activity 300 is a procedure 371 of retrieving and loading the configurations and settings for the new profile. In some examples, profile management module 115 (FIG. 1) can retrieve the configurations and settings for the new profile from storage component 119 (FIG. 1). In other examples, profile management module 115 (FIG. 1) can retrieve the configurations and settings for the new profile from other computers over network 130 (FIG. 1).

After retrieving the configurations and settings, profile management module 115 (FIG. 1) can implement the configurations and settings. For example, the configurations and settings can include settings regarding the visibility and accessibility of a desktop, a start button, and a taskbar. In various embodiments, the desktop can be the desktop of operating system 118 (FIG. 1). The start button can be a button or other items on the desktop of operating system 118 (FIG. 1) that allows a user to access one or more applications or files. If the operating system is the Microsoft® Windows® OS, the start button can be the start button located on the Windows® taskbar. If the operating system is Apple Computers' Mac OS X, the start button could be the dock menu, which is usually located at the bottom of the desktop.

In many embodiments, the taskbar refers to a taskbar of applications that are available to a user when the user is logged-in to desktop management system 100 (FIG. 1). The taskbar can contain one or more buttons or menus that allow the user to start one or more application and access files in storage component 119 (FIG. 1) or files over network 130 (FIG. 1). In some embodiments, the taskbar can be a taskbar generic to operating system 118 (FIG. 1) or a taskbar generic to all users of desktop management system 100 (FIG. 1). In other embodiments, the taskbar can be a custom-designed taskbar for a specific user or a group of users in a specific field, organization, and/or location. For example, the taskbar could be a taskbar specifically designed for doctors or nurses at a specific hospital or department of the hospital.

In various examples, the configurations and settings of the start profile can include settings that block access to the desktop, start button, and taskbar. Access to the desktop, start button, and taskbar can be blocked by the start profile to force the user to login to desktop management system 100 (FIG. 1). In this manner, the user is not allowed to circumvent the login process by accessing applications or files using the desktop, start button, or taskbar.

Referring again to FIG. 3, activity 300 can include a procedure 372 of determining whether to start any applications. In some examples, a profile can include instructions to start one or more applications after switching to the profile. In many embodiments, profile management module 115 (FIG. 1) can determine if the current profile includes instruction to start any applications that are not currently running. Also, in procedure 372, profile management module 115 (FIG. 1) can determine the order to start the application based on the configuration and settings of the profile. In some examples, the profile can include explicit instruction on the order that the applications are to be started.

In some instances, the profile includes instructions to start one or more applications that are already running In this situation, profile management module 115 (FIG. 1) does not restart or start a second instance of the already running application(s) unless the setting of the profile includes instructions to start more than one instance of the application(s).

If the current profile does not include instructions to start any applications that are not currently running, procedure 372 is complete. In the example where the current profile is the start profile and the start profile does not include any instructions to start any application that are not currently running, the next activity is activity 253 (FIG. 2).

If the current profile includes instructions to start one or more applications that are not currently running, the next procedure in activity 300 is procedure 373 of determining if any time delay is required before starting the next application. In some examples, profile management module 115 (FIG. 1) determines the next application to start based on the setting and configuration of the profile and whether a time delay is required before starting the next application.

If a time delay is not required before starting the next application, the next procedure in activity 300 is a procedure 375 of starting the application. If a time delay is required, the next procedure in activity 300 is procedure 374 of waiting the predetermined delay time (e.g., thirty seconds). In some examples, profile management module 115 (FIG. 1) can time the delay before starting the next application. After waiting the predetermined delay time, the next procedure in activity 300 is procedure 375 of starting the application. In some examples, profile management module 115 (FIG. 1) can start the application. After starting the application, the next procedure in activity 300 is procedure 372 of determining whether to start any additional applications.

In some examples, the one or more applications started by the start profile can include a login application. The login application allows authorized users to securely login to desktop management system 100 (FIG. 1). In various embodiments, the login can be a single sign-on (SSO) login. The SSO login can allow a user to login to multiple applications with a single login to desktop management system 100. For example, the SSO login could be configured to allow the user to access all applications and data, for which the user is authorized to access, without having to login into any additional systems or applications after logging in the first time. Also, in some examples, the one or more applications started by the start profile can include a toolbar specific to desktop management system 100 (FIG. 1) and an application to communicate context changes among applications. As example of an application that can communicate context changes among applications is described in U.S. patent application Ser. No. 11/608,000, which is incorporated herein by reference.

Referring again to FIG. 2, after switching to the start profile, the next activity in method 200 is an activity 253 of receiving login information from a user and validating an identity of the user. In some examples, an authorized user logs-in to desktop management system 100 (FIG. 1) using the SSO login application started in activity 252.

FIG. 4 illustrates a flow chart for an embodiment of an activity 253 of receiving login information from a user and validating an identity of the user, according to the first embodiment. Activity 253 is merely exemplary and is not limited to the embodiments presented herein. Activity 253 can be employed in many different embodiments or examples not specifically depicted or described herein.

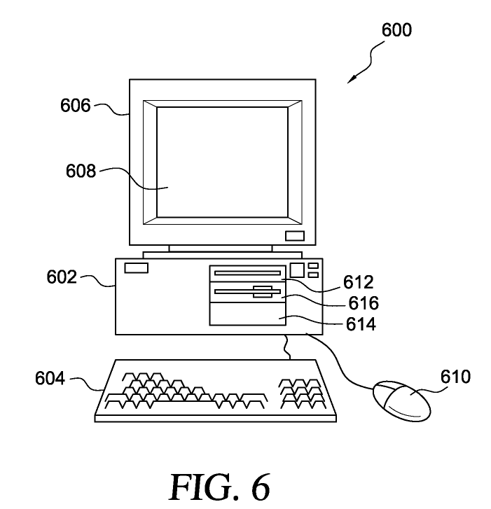

Turning to FIG. 4, activity 253 in FIG. 4 can include a procedure 471 of requesting login information. Login module 111 (FIG. 1) can request login information (e.g., a username and password) from the user. For example, login module 111 (FIG. 1) can request the login information from the user by providing a window (e.g., a login graphic) on a monitor 606 (FIG. 6) of workstation 140 or 141 (FIG. 1) where the user can enter the login information.

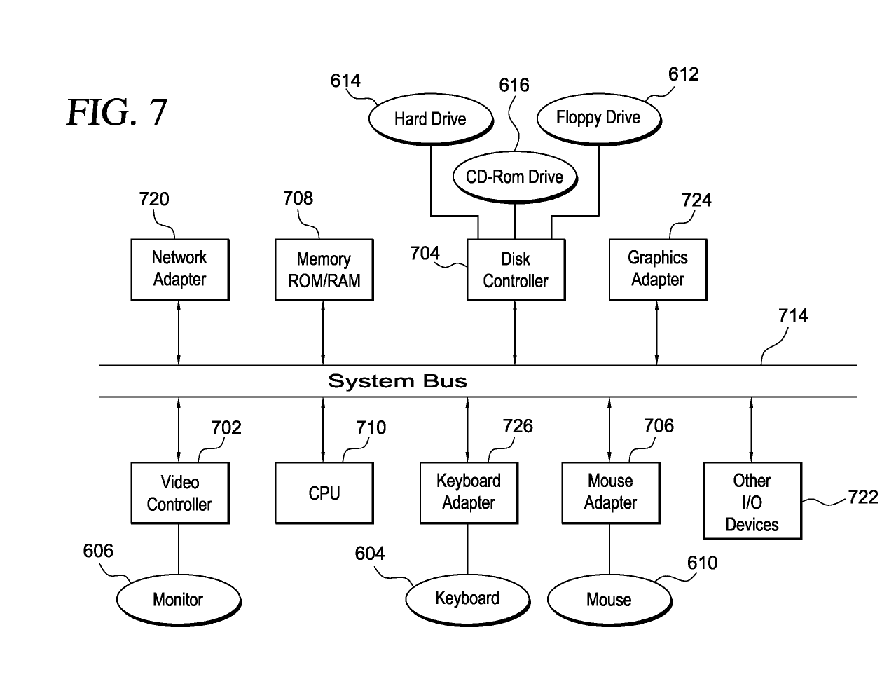

Subsequently, activity 253 in FIG. 4 can include a procedure 472 of receiving login information. In some examples, the user can enter the information in a window on monitor 606 (FIGS. 6 and 7) and click submit using mouse 610 (FIGS. 6 and 7).

The next procedure in activity 253 of FIG. 4 is a procedure 473 of authenticating the login information. In some examples, login module 111 (FIG. 1) can compare the login information with the login information stored for that user. If the login information matches, the user is validated to use the workstation. After procedure 473, activity 253 is complete.

Referring again to FIG. 2, after an authorized user successfully logins into the desktop management system, method 200 continues with an activity 254 of switching to an autolaunch profile. In some examples, switching to the autolaunch profile can be apart of an autolaunch sequence. In some examples, profile management module 115 (FIG. 1) can perform the switch to the autolaunch profile. In many embodiments, the autolaunch profile is an intermediate profile between the start profile and an operational profile. The autolaunch profile can be used to ensure that all the applications necessary for proper usage of desktop management system 100 (FIG. 1) are properly started.

In many examples, the autolaunch profile can continue to disable access to the desktop, the start button, and the taskbar in some examples. The autolaunch profile can run quickly enough, in some examples, so that the desktop, start button, and taskbar do not need to be enabled. Additionally, as part of the autolaunch profile, one or more pervasive applications can be started. In other examples, method 200 does not include activity 254 of switching to an autolaunch profile. In these examples, the one or more applications started by the autolaunch profile can be started by the operational and/or start profile.

After the autolaunch profile has completed starting the applications, the next activity in method 200 is an activity 255 of switching to an operational profile. The operational profile is a profile used during normal operation of desktop management system 100 (FIG. 1) by a user. In some examples, the operational profile is generic for all users or generic for a sub-group of all of the users. In other examples, each user can have a different and/or customized operational profile. Like other profiles, the operational profile can be started using the procedures described in activity 300 of FIG. 3. In some examples, the operational profile does not include instructions to start any applications that were not started by the autolaunch profile.

In some examples, the configurations and settings of the operational profile allow the user to access the taskbar, but not the desktop or the start button. In many embodiments, the user is allowed access to a taskbar designed for use with desktop management system 100. Allowing access to the taskbar permits the user to see and access one or more applications while still allowing desktop management system 100 (FIG. 1) to maintain control over which applications the user can access. In other examples, the configuration and settings of the operational profile allows the user to access two or more of the taskbar, the desktop, and/or the start button.

Additionally, one or more applications started by the start profile and/or the autolaunch profile can still be running The operational profile can label some or all of these applications as pervasive applications, and thus, desktop management system 100 (FIG. 1) will kept the application active while the operational profile is the current profile.

After switching to the operational profile, the user of the workstation is free to use the workstation. In the background, however, one or more further activities can simultaneously occur which the user uses the workstation. These background activities can keep desktop management system 100 (FIG. 1) operating properly and enhance the usability of desktop management system 100 (FIG. 1).

For example, after switching to the operational profile, method 200 of FIG. 2 can include an activity 256 of determine whether all of the pervasive applications are running That is, all of the pervasive applications can be monitored to determine if these applications are still active. In these examples, pervasive monitoring module 112 (FIG. 1) can check to see if all of the pervasive applications are still running In some examples, pervasive monitoring module 112 (FIG. 1) can check if these applications are active by monitoring the list of active applications maintained by the operating system.

In some examples, pervasive monitoring module 112 can monitor the status of the pervasive applications at predetermined time intervals (e.g., thirty seconds). If all of the pervasive applications are running, the next activity in method 200 is an activity 258 of monitoring network connectivity between a network and the workstation

If at least one pervasive application is not running, method 200 of FIG. 2 includes an activity 257 of restarting the at least one pervasive application. In some examples, restart module 113 (FIG. 1) can restart any non-active pervasive applications. In some examples, after restarting the at least one non-running pervasive application, the next activity in method 200 is the activity 258.

Method 200 can include an activity 258 of monitoring network connectivity to a network by the workstation. In some examples, activity 258 can include network monitor module 117 (FIG. 1) monitoring the connection between network 130 (FIG. 1) and workstation 140 and/or 141. In some examples, the global setting for desktop management system 100 (FIG. 1) can include one or more target internet protocol (IP) addresses to attempt to contact (e.g., ping) to check the network connectivity. In other examples, the settings and configurations of the operational profile can include one or more target computer IP address. The global settings or the settings and configurations of the operational profile can also include information on the number of times (e.g., three) that network monitor module 117 (FIG. 1) will attempt to contact the target IP address before determining that the network connection has failed.

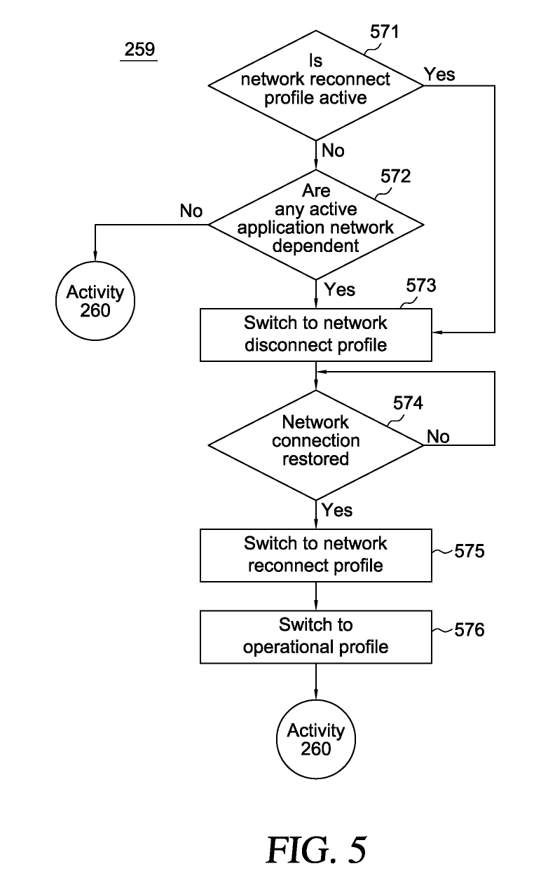

If the network connection between the network and the workstation is active, the next activity in method 200 is an activity 260 of determining whether a trigger occurred. If a network connectivity failure is detected, the next activity in method 200 is an activity 259 of performing a network reconnection. FIG. 5 illustrates a flow chart for an embodiment of an activity 259 of performing a network reconnection, according to the first embodiment.

Turning to FIG. 5, activity 259 can include a first procedure 571 of determining whether a network reconnect profile is active. The network reconnect profile could be the active profile because profile management module 115 (FIG. 1) could have switched to the network reconnect profile in response to a trigger in activity 261 in a previous iteration of method 200. In some examples, profile management module 115 (FIG. 1) can determine if the active profile is the reconnect profile. If the reconnect profile is active, the next procedure in activity 253 is procedure 573.

If the network reconnect profile is not active, the next procedure in activity 259 is a procedure 372 of determining whether any active applications are network dependent. An application is network dependent if the application requires access to network 130 to function properly. For example, an internet browser or an application that access data from a remote server over network 130 (FIG. 1) can be considered network dependent applications. In some examples, as described above, the configurations and settings for each of the active applications can include information on whether the applications are network dependent. In other examples, network monitor module 117 (FIG. 1) can determine whether a specific application is network dependent. If none of the active applications are network dependent, activity 259 is complete and the next activity is activity 260 (FIG. 2).

If one or more of the active applications are network dependent, activity 259 continues with a procedure 573 of switching to a network disconnect profile. In some examples, switching to the network disconnect profile can be performed in part using activity 300. In additional to the method described in activity 300 of FIG. 3, the network disconnect profile can also suspend or kill any applications that are network dependent. Also, in some examples, when a user starts an application, profile management module 115 (FIG. 1) can check if the application is network dependent and can inform the user that an application will not function properly because no network connection exists. In some embodiments, profile management module 115 (FIG. 1) can delay starting the network dependent application until the network connectivity is reestablished. The network disconnect profile does not affect the operation of applications that are not network dependent. In some examples, the switching from the operation profile to the network disconnect profile can be invisible or transparent to the user.

Subsequently, activity 259 of FIG. 5 continues with a procedure 574 of determining whether the network connectivity has been restored. If the network connection is not reestablished, the network monitor module 117 (FIG. 1) can continue to monitor the network connection until the network connectivity is restored.

If the network connectivity has been restored, the next procedure in activity 259 is a procedure 575 of switching to a network reconnect profile. In some examples, switching to the network reconnect profile can be performed using at least in part activity 300 of FIG. 3. The network reconnect profile can attempt to reestablish the proper functioning of the one or more network dependent applications. That is, network monitor module 117 (FIG. 1) can perform one or more tasks to restore the proper functioning of one or more computer applications after determining that the network connectivity to the network by the workstation has been reestablished. For example, network monitor module 117 (FIG. 1) can restart one or more network dependent applications stopped by the network disconnect profile. In addition, network reconnect profile can start any application whose start was delayed by the network disconnect profile because of a lack of a network connectivity.

Activity 259 next includes a procedure 576 of switching back to the operational profile in some examples. Switching to the operational profile can be similar to activity 252 (FIG. 2). After procedure 576, activity 259 is complete, and the next activity is activity 260 of FIG. 2.

Referring again to FIG. 2, method 200 includes an activity 260 of determining if a trigger occurred. If a trigger occurs, the next activity in method 200 is an activity 261 of performing a trigger sequence. If a trigger has not occurred, the next activity is an activity 262 of determining whether a user wants to logout of desktop management system 100 (FIG. 1).

A trigger is an event whose occurrence (or lack of occurrence) causes one or more responses by desktop management system 100 (FIG. 1). Although in method 200 the loss of network connectivity is determined in activity 258, in some examples, the loss of network connectivity could be considered a trigger.

In another example, the workstation being idle for a predetermined time period (e.g., five minutes) could be considered a first idle trigger, and a trigger sequence associated with this trigger would occur. In this example, desktop management module 110 (FIG. 1) can be monitoring in activity 260 for the occurrence of the first idle trigger. In some examples, after workstation 140 (FIG. 1) is idle for a predetermined time (i.e., the first idle trigger occurs), desktop management module 110 (FIG. 1) can start a lockout application (and screen saver) that requires a user to login again to access workstation 140 (FIG. 1). Starting the lockout application (and screen saver) could be considered the trigger sequence associated with the idle trigger.

In the same or different example, after the first idle trigger has occurred, desktop management module 110 (FIG. 1) can wait a second predetermined time (e.g., thirty minutes) before activating a second idle trigger if the workstation is still idle. In some examples, when the second idle trigger occurs, desktop management module 110 can switch to a new profile using the method described in activity 300 (FIG. 3). In some examples, the new profile can be the logout profile, which logs the user out of workstation 140. In other examples, other profiles can be activated that activate one or more applications. In one example, profile management module 115 (FIG. 1) can switch the desktop management module 110 (FIG. 1) to an idle profile. The idle profile can close one or more applications and put the workstation in a power-down or idle state until the user logs in again to the system.

Another example of a trigger is the starting of a specific application. For example, a user can start a first application, and the starting of this first application can act a trigger. The trigger sequence can be the starting of one or more second applications. In other embodiments, starting the first application causes profile management module 115 to start a new profile, and the new profile starts the one or more second applications

After performing the trigger sequence, the next activity in method 200 is activity 262 of determining whether a user wants to logout of desktop management system 100 (FIG. 1) (i.e., desktop management system 100 has received instructions to logout from the user). In some examples, a user can indicate she wants to logoff of desktop management system 100 (FIG. 1) by clicking a button on the taskbar. In other examples, a user can click a combination of buttons on a keyboard (e.g., control-alt-delete) to indicate that she wants to logout. If a user has not indicated that she wants to logout, the next activity in method 200 is activity 256.

If a user has indicated she want to logout, the next activity in method 200 is an activity 263 of switching to a logout profile. In some examples, logout module 116 (FIG. 1) can switch desktop management system 100 (FIG. 1) to the logout profile and manage the logout sequence. The logout profile can hide or disable the taskbar, start button, and the desktop, and can log the user out from desktop management system 100 (FIG. 1) and any other applications into which the user is logged-in. In some examples, the method described in activity 300 can be used to switch to the logout profile. In other examples, other methods can be used because the logout profile is closing applications rather than starting applications.

The logout profile can close all active applications, include any pervasive applications. In some examples, the order in which the one or more active applications are closed can be included in the configurations and settings of the logout profile. That is, in some instances, a second application must still be active to properly shut down a first application. For example, a first application can access data remotely over network 130 and require a network connectivity between workstation 140 and network 130 to close properly. Thus, the closing sequence in the logout profile can specify the first application is closed before the application providing network connectivity is closed. In these embodiments, before the logout profile is activated, a system administration or a user can set the closing sequence of applications.

In some examples, after closing the active applications and performing other logoff tasks, the next activity in method 200 is activity 252 of switching to the start profile. Switching back to the start profile, allows usage of the workstation by the same or a different user after validating login information from the user.

In some examples, activities 256-257, activities 258-259, and/or activities 260-261 can occur simultaneously with each other or in a different order than described above. In some examples, each of the activities 256, 258, and 260 can run on a different thread in operating system 118 (FIG. 1) and, thus, run simultaneously.

FIG. 6 illustrates a computer 600 that is suitable for implementing an embodiment of desktop management system 100 (FIG. 1). Computer 600 includes a chassis 602 containing one or more circuit boards (not shown), a floppy disc drive 612, a Compact Disc Read-Only Memory (CD-ROM) or digital video disc (DVD) drive 616, and a hard drive 614. A representative block diagram of the elements included on the circuit boards inside chassis 602 is shown in FIG. 7. A central processing unit (CPU) 710 in FIG. 7 is coupled to a system bus 714 in FIG. 7. In various embodiments, the architecture of CPU 710 can be compliant with any of a variety of commercially distributed architecture families including the RS/6000 family, the Motorola 68000 family, or the Intel x86 family.

System bus 714 also is coupled to memory 708 that includes both read only memory (ROM) and random access memory (RAM). Non-volatile portions of memory 708 or the ROM can be encoded with a boot code sequence suitable for restoring computer 600 (FIG. 6) to a functional state after a system reset. In addition, memory 708 can include microcode such as a Basic Input-Output System (BIOS). In some example, memory 708 can include storage component 119 (FIG. 1).

In the depicted embodiment of FIG. 7, various I/O devices such as a disk controller 704, a graphics adapter 724, a video controller 702, a keyboard adapter 726, a mouse adapter 706, a network adapter 720, and other I/O devices 722 can be coupled to system bus 714. Keyboard adapter 726 and mouse adapter 706 are coupled to a keyboard 604 (FIGS. 6 and 7) and a mouse 610 (FIGS. 6 and 7), respectively, of computer 600 (FIG. 6). While graphics adapter 724 and video controller 702 are indicated as distinct units in FIG. 7, video controller 702 can be integrated into graphics adapter 724, or vice versa in other embodiments. Video controller 702 is suitable for refreshing a monitor 606 (FIGS. 6 and 7) to display images on a screen 608 (FIG. 6) of computer 600 (FIG. 6). Disk controller 704 can control hard drive 614 (FIGS. 6 and 7), floppy disc drive 612 (FIGS. 6 and 7), and CD-ROM or DVD drive 616 (FIGS. 6 and 7). In other embodiments, distinct units can be used to control each of these devices separately.

Although many other components of computer 600 (FIG. 6) are not shown, such components and their interconnection are well known to those of ordinary skill in the art. Accordingly, further details concerning the construction and composition of computer 600 and the circuit boards inside chassis 602 (FIG. 6) need not be discussed herein.

When computer 600 in FIG. 6 is running, application instructions stored on a floppy disc in floppy disc drive 612, on a CD-ROM or DVD in CD-ROM or DVD drive 616, on hard drive 614, or in memory 708 (FIG. 7) are executed by CPU 710 (FIG. 7). A portion of the application instructions, stored on these devices, can be suitable for carrying out method 200 (FIG. 2) as described previously with respect to FIGS. 1-5.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that activities 251-263 of FIG. 2, procedures 371-375 of FIG. 3, activities 471-473 of FIG. 4, procedures 571-576 of FIG. 5, or any element of FIG. 1 may be comprised of many different activities, procedures and be performed by many different modules, in many different orders and that the foregoing discussion of certain of these embodiments does not necessarily represent a complete description of all possible embodiments. Moreover, activities 251-263 of FIG. 2, procedures 367-375 of FIG. 3, activities 471-473 of FIG. 4, and procedures 571-576 of FIG. 5 can be performed in real time. In other examples, computer 600 in FIG. 6 can be replaced with a cluster or collection of computers.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method of managing usage of a workstation, the method comprising:
performing a desktop management sequence;
performing a start-up sequence;
displaying a login graphic on a screen of a monitor of the workstation;
receiving first login information from a user;
validating the first login information to check if the user is authorized to use the workstation;
if the user is authorized to use the workstation, logging the user into the workstation;
if the user is authorized to use the workstation, performing an autolaunch sequence, wherein performing the autolaunch sequence comprises:
starting one or more pervasive computer applications and wherein starting the one or more pervasive computer applications comprises:
checking if the one or more pervasive computer applications is active; and
if at least one first application of the one or more pervasive computer applications is not active, starting the at least one first application of the one or more pervasive computer applications;
receiving one or more instructions to logout from the user; and
logging the user out of the workstation.

2. The method of claim 1, wherein:
performing the start-up sequence comprises:
switching to a start-up profile.

3. The method of claim 1, wherein:
performing the autolaunch sequence further comprises:
switching to an autolaunch profile.

4. The method of claim 1, wherein:
performing the autolaunch sequence further comprises:
starting a first application;
waiting a predefined time period; and
after waiting the predefined time period, starting a second application.

5. The method of claim 4, wherein:
the one or more pervasive applications comprise the first application and the second application.

6. The method of claim 4, wherein:
performing the autolaunch sequence further comprises:
starting a third application after starting the second application.

7. The method of claim 1, wherein:
performing the desktop management sequence comprises:
stopping the user from accessing one or more non-approved computer applications.

8. The method of claim 1, further comprising:
blocking usage of the workstation after an occurrence of a trigger event; and
after blocking usage of the workstation, allowing usage of the workstation after validating second login information from the user.

9. The method of claim 8, wherein:
the trigger event is a lack of activity by the user on the workstation for a predetermined time period.

10. The method of claim 1, further comprising:
monitoring network connectivity between a network and the workstation.

11. The method of claim 10, further comprising:
determining that the network connectivity is lost.

12. The method of claim 11, further comprising:
determining that the network connectivity is reestablished; and
performing one or more tasks to restore functionality of at least one first computer application after determining that the network connectivity between the network and the workstation is reestablished,
wherein:
the at least one first computer application is dependent on the network connectivity for proper functioning.

13. The method of claim 1, further comprising:
closing the one or more pervasive computer applications after received the one or more instructions to logout from the user.

14. A method of desktop management of a workstation, the method comprising:
switching to a first profile to prepare a desktop of the workstation for use by a user;
switching to a second profile, wherein switching to the second profile comprises:
starting one or more first computer applications where a first application of the one or more first computer applications requires a connection to a network to operate properly;
monitoring to determine if a second application of the one or more first computer applications is still running at one or more first predetermined intervals;
if the second application of the one or more first computer applications is not running, starting the second application of the one or more first computer applications;
monitoring to determine if the connection to the network is still active at one or more second predetermined intervals;
if the connection to the network is inactive, switching to a network disconnect profile; and
if the connection to the network becomes active after being inactive, switching to a network reconnect profile.

15. The method of claim 14, further comprising:
switching to a third profile after starting the one or more first computer applications;
wherein switching to the third profile occurs after switching to the network reconnect profile.

16. The method of claim 14, wherein:
switching to the first profile comprises:
blocking access of the user to one or more second computer applications, switching to the second profile further comprises:
continuing to block access of the user to the one or more second computer applications.

17. The method of claim 14, wherein:
starting the one or more first computer applications comprises:
starting the first application of the one or more first computer applications;
starting the second application of the one or more first computer applications;
waiting a predefined time period; and
after waiting the predefined time period, starting a third application of the one or more first computer applications.

18. A system configured to manage a workstation, the system comprising:
a login module configured to login a user and validate login information of the user;
a pervasive monitoring module configured to monitor that one or more pervasive computer applications are running while the user is logged-in to the workstation;
a start-up module configured to start the one or more pervasive computer applications if the one or more pervasive computer applications are not running;
a profile management module configured to manage one or more profiles;
a logout module configured to logout the user; and
a network monitor module configured to monitor a network connection to a network and manage usage of the network by one or more first computer applications,
wherein:
the one or more first computer applications comprise the one or more pervasive computer applications.

19. The system of claim 18, wherein:
at least one of the login module, the pervasive monitoring module, the start-up module, the profile management module, the logout module, or the network monitor module are running on a first computer; and
at least one of the login module, the pervasive monitoring module, the start-up module, the profile management module, the logout module, or the network monitor module are running on one or more second computers.

20. The system of claim 18, wherein:
the login module, the pervasive monitoring module, the start-up module, the profile management module, the logout module, and the network monitor module are running on a first computer.

21. The system of claim 20, wherein:
the first computer comprises the workstation.

22. A computer-readable medium that stores instructions executable by at least one processor, the computer-readable medium comprising:
instructions for performing a desktop management sequence;
instructions for performing a start-up sequence;
instructions for displaying a login graphic on a screen of a monitor of the workstation;
instructions for receiving first login information from a user;
instructions for validating the first login information to check if the user is authorized to use the workstation;
instructions for logging the user into the workstation if the user is authorized to use the workstation;
instructions for performing an autolaunch sequence if the user is authorized to use the workstation, wherein performing the autolaunch sequence comprises:
starting one or more pervasive computer applications and wherein starting the one or more pervasive computer applications comprises:
checking if the one or more pervasive computer applications is active; and
instructions for starting the at least one first application of the one or more pervasive computer applications if at least one first application of the one or more pervasive computer applications is not active;
instructions for receiving one or more instructions to logout from the user; and
instructions for logging the user out of the workstation.
